(19) United States
(12) Patent Application Publication
(10) Pub. No.: US 2017/0173556 A1
(43) Pub. Date: Jun. 22, 2017

(54) ADSORPTION MATERIAL AND METHOD OF MANUFACTURING THE SAME AND ADSORPTION HEAT PUMP

(71) Applicant: Industrial Technology Research Institute, Hsinchu (TW)

(72) Inventors: Jian-Hong LEE, Tianzhong Township (TW); Chien-Yun HUANG, Zhudong Township (TW); Yu-Hao KANG, Zhubei City (TW); Ming-Shan JENG, Hsinchu City (TW); Shan-Ling PENG, Chiayi City (TW)

(73) Assignee: Industrial Technology Research Institute, Hsinchu (TW)

(21) Appl. No.: 14/974,466

(22) Filed: Dec. 18, 2015

(51) Int. Cl. B01J 20/20; F25B 30/04; B01J 20/28; B01J 20/30; B01J 20/26; B01J 20/22

(52) U.S. Cl. CPC B01J 20/20; B01J 20/261; B01J 20/22; B01J 20/28014; B01J 20/3085; F25B 30/04

(57) ABSTRACT

An adsorption material is provided, which includes a graphene scroll of a graphene sheet wrapping along an axis. The graphene scroll has a spiral shape at a cross-section perpendicular to the axis. A modifier is grafted on an interlayer and outside of the graphene scroll, and the modifier has a hydrophilic group.

### TECHNICAL FIELD

The technical field relates to an adsorption material, and a method of manufacturing the adsorption material and an application of the adsorption material.

### BACKGROUND

Compared to air compression refrigeration, adsorption refrigeration has the advantages of being stable, reliable, energy-saving, environmentally protection, and quiet. The adsorption material of an adsorption heat-pump may release water vapor by adsorbing heat energy, and adsorbing condensed water vapor at a cold end. The cooling and heating cycle of the adsorption material may transfer heat energy into cooling energy. Theoretically, the specific cooling power (SCP) of the adsorption material is related to the adsorption amount, the adsorption/desorption rate, and the thermal exchange. A normal porous material may only adsorb an amount of water that is equal to its pore volume. In other words, the adsorption ability of a normal porous material is limited, and such a material cannot be a candidate for an air condition unit using an adsorption heat pump. Normal adsorption materials have shortcomings, such as a low amount of adsorption and a slow adsorption rate. General methods for modifying the adsorption material include increasing its specific surface area, increasing its pore size, or increasing the amount of high thermal conductivity material used. However, the above methods lead to lower the thermal conductivity or reduce the desorption rate of the adsorption material. In addition, the increased pore size may cause the structure of the adsorption material to collapse. Therefore, the life-cycle of the adsorption material is decreased.

Accordingly, there is a need for a novel adsorption material to be applied in a heat pump.

### SUMMARY

One embodiment of the disclosure provides an adsorption material, comprising: a graphene scroll of a graphene sheet wrapping along an axis, wherein the graphene scroll has a spiral shape at a cross-section perpendicular to the axis; and a modifier grafting on an interlayer and outside of the graphene scroll, wherein the modifier has a hydrophilic group.

One embodiment of the disclosure provides a method of manufacturing an adsorption material, comprising: (a) mixing a graphite and an intercalator to form a first intercalated graphite; (b) mixing the first intercalated graphite and a modifier to form a mixture, and applying a microwave to the mixture to form a second intercalated graphite; (c) putting the second intercalated graphite in an alcohol for a supersonic vibration to form an adsorption material, wherein the adsorption material includes: a graphene scroll of a graphene sheet wrapping along an axis, wherein the graphene scroll has a spiral shape at a cross-section perpendicular to the axis; and the modifier grafting on an interlayer and outside of the graphene scroll, wherein the modifier has a hydrophilic group.

One embodiment of the disclosure provides an adsorption heat pump, comprising: an adsorption/desorption portion including an adsorption material for adsorbing/desorbing a refrigerant; and an evaporation portion for evaporating the refrigerant, wherein the evaporation portion connects to the adsorption/desorption portion; and a condensation portion for condensing the refrigerant, wherein the condensation portion connects to the adsorption/desorption portion, wherein the adsorption material includes: a graphene scroll of a graphene sheet wrapping along an axis, wherein the graphene scroll has a spiral shape at a cross-section perpendicular to the axis; and a modifier grafting on an interlayer and outside of the graphene scroll, wherein the modifier has a hydrophilic group.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows a cross sectional view of an adsorption material in one embodiment of the disclosure.

FIG. 2 shows an adsorption heat pump in one embodiment of the disclosure.

FIGS. 3A, 3B, 4A, and 4B show TEM photographs of a product in one embodiment of the disclosure.

FIG. 5 shows XRD spectra of a product in a dry state and a water adsorbing state in one embodiment of the disclosure.

FIG. 6 shows IR spectra of PMAA, a graphene scroll, and a PMAA grafted graphene scroll in embodiments of the disclosure.

FIG. 7 shows water adsorption weight amount/adsorption material dry weight (%) versus period curves of different adsorption materials.

FIG. 8 shows water desorption weight amount/adsorption material dry weight (%) versus period curves of different adsorption materials.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

One embodiment of the disclosure provides a method of manufacturing an adsorption material. First, (a) mixing a graphite and an intercalator to form a first intercalated graphite. The intercalator can be sulfuric acid, perchloric acid, nitric acid, phosphoric acid, stearic acid, or a combination thereof. For example, the graphite can be put into the intercalator such as a solution of perchloric acid and nitric acid, and then stirred until the graphite stopped bubbling, thereby obtaining the first intercalated graphite.

Subsequently, the method further (b) mixes the first intercalated graphite and a modifier to form a mixture, and then applying a microwave to the mixture, such that the modifier enters the interlayer of the first intercalated graphite to graft thereon. As such, a second intercalated graphite is formed. The modifier has a hydrophilic group, such as a surfactant, a hydrophilic polymer, or a combination thereof. For example, the surfactant can be sodium dodecylbenzenesulfonate (SDBS), polyoxyethylene ether sulfate (e.g. AES), polyoxyethylene alkyl ether (e.g. APEO), or polyethylene polyamine fatty acid amine salt (e.g. AE). The hydrophilic polymer may have a weight average molecular weight (Mw) of 10000 to 500000. If a hydrophilic polymer has an overly high Mw, its molecular chains cannot be easily thermally disturbed. As a result, the adsorption of water between the molecular chains cannot be broken at a low temperature to be desorbed, thereby degrading the water desorption property of the adsorption material. For example, the hydrophilic polymer includes poly(methacrylic acid) (PMAA), poly(ethylene glycol) (PEG), polyacrylonitrile (PAN), acrylic ester-acrylamide copolymer, ethylene-maleic anhydride copolymer, carboxylicmethyl cellulose, or starch-grafted polyacrylonitrile. Alternatively, the hydrophilic polymer has hydrophilic groups of sodium sulfonate, and the hydrophilic polymer includes poly(styrenesulfonate) (PSS) or sodium lignosulfonate. In a further embodiment, the hydrophilic polymer has hydrophilic groups of amine, and the hydrophilic polymer includes polyacrylamide (PAM), polyvinylpyrrolidone (PVP), polyethylenimine (PEI), or poly(diallyldimethylammonium chloride) (PDDA). On the other hand, the graphite and the modifier have a weight ratio of 1:0.5 to 1:5. Too little modifier cannot efficiently increase the water adsorption amount of the product. Too much modifier has too much hydrophilic groups (e.g. COO⁻) that will form hydrogen bonds with water, such that water cannot be easily desorbed.

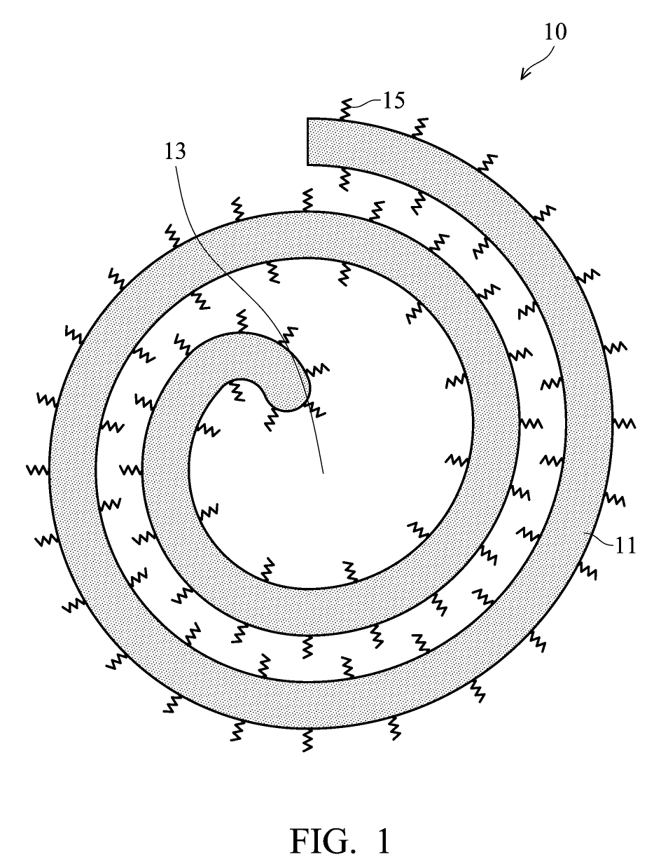

Subsequently, the method further (c) puts the second intercalated graphite in an alcohol for a supersonic vibration, such that the second intercalated will be separated to graphene sheets, and the graphene sheet wraps along an axis to form a graphene scroll. In one embodiment, the alcohol can be general one such as ethanol. As shown in FIG. 1, the graphene scroll 11 of the adsorption material 10 has a spiral shape at a cross-section perpendicular to the axis 13, and the modifiers 15 graft on an interlayer and outside of the graphene scroll 11. It should be understood that the cross-section as shown in FIG. 1 is just for illustration, the graphene scroll 11 may have more or fewer wrapping layers, and the distance between the different interlayer can be different. Note that the order of the steps (a), (b), and (c) cannot be arbitrarily changed. For example, if step (a) is omitted, the modifier is directly mixed with graphite, and the mixture is then applied a microwave, the modifier cannot enter the interlayer of the non-intercalated graphite due to the interlayer distance of the graphite being too short to intercalate the modifier. As a result, the modifier will only graft onto the outside of the graphite, and the modifier will not graft on the interlayer of the graphene scroll product. On the other hand, if the modifier is added after performing steps (a) and (c), the modifier will only graft on the outside of the graphene scroll without grafting on the interlayer of the graphene scroll, thereby dramatically reducing the water adsorption property of the product.

Alternatively, the modifier grafted graphene scroll can be further covered by a water retention agent, thereby keeping its water adsorption amount after several adsorption/desorption cycles. In one embodiment, the water retention agent includes sodium alginate, poly acrylic acid or a salt thereof, poly ethylene glycol, or polyvinyl alcohol.

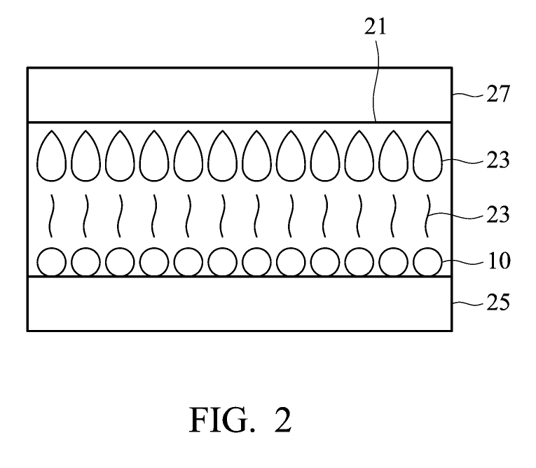

In one embodiment, the described adsorption material can be applied in an adsorption heat pump. As shown in FIG. 2, the adsorption heat pump 20 may include an adsorption/desorption portion 21 with the adsorption material 10 for adsorbing/desorbing a refrigerant 23. The adsorption heat pump 20 also includes an evaporation portion 25 for evaporating the refrigerant 23, and the evaporation portion 25 connects to the adsorption/desorption portion 21. The adsorption heat pump 20 also includes a condensation portion 27 for condensing the refrigerant 23, and the condensation portion 27 connects to the adsorption/desorption portion 21. In one embodiment, the refrigerant 23 is water. The principle and details of the adsorption heat pump may refer to U.S. Pat. No. 7,497,089.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

In following Examples, the hydrophilic polymer was poly(methacrylic acid) (PMAA, Mw=130000, CAT709 commercially available from Scientific polymer products, Inc.). The surfactant was sodium dodecylbenzenesulfonate (SDBS). The graphite material was graphite powder with a particle size less than 100 mesh (EGS-743, commercially available from Central Carbon Co., Ltd.).

### Comparative Example 1

### Graphene Scroll

Appropriate amount of graphite powder was added into 200 mL of perchloric acid (70-72 wt %)/nitric acid (>65 wt %) (v/v=0.25 to 1), and then evenly stirred until the graphite powder stopped bubbling (for about 2 hours). As such, a graphite intercalated by the perchloric acid and the nitric acid was obtained, which had an appearance of expansion and suspension. The perchloric acid/nitric acid intercalated graphite was added into an excess amount of ethanol to be supersonic vibrated until no bubbles were produced (for about 1 hour). The excess intercalator and ethanol were removed by centrifugal washing, thereby obtaining a graphite scroll.

### Example 1

### (PMAA Grafted Graphene Scroll)

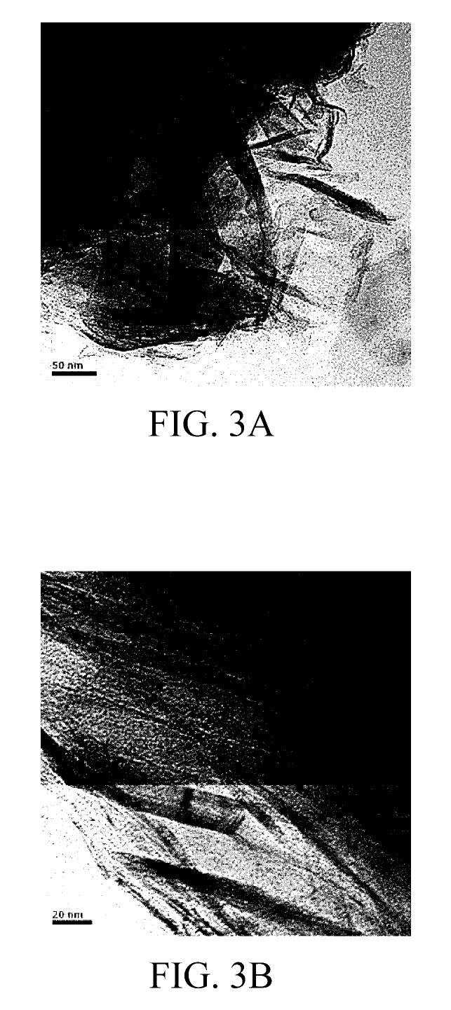

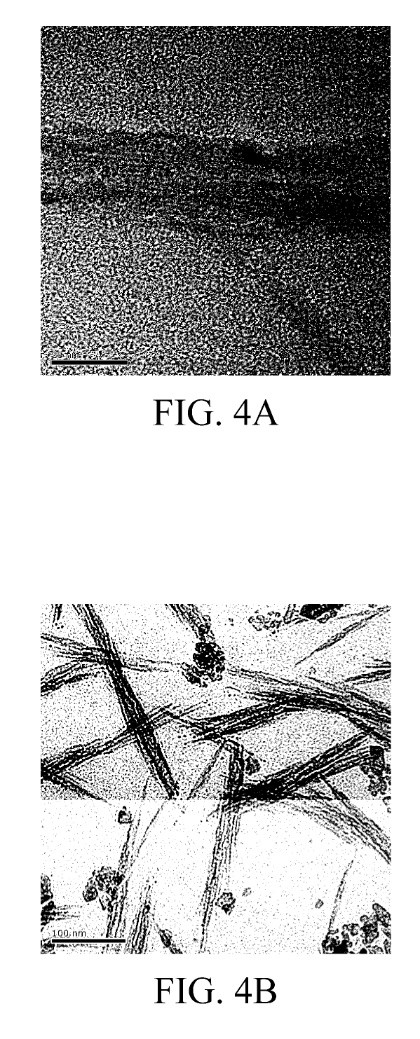

Appropriate amount of graphite powder was added into 200 mL of perchloric acid (70-72 wt %)/nitric acid (>65 wt %) (v/v=0.25 to 1), and then evenly stirred until the graphite powder stopped bubbling (for about 2 hours). As such, a graphite intercalated by the perchloric acid and the nitric acid was obtained, which had an appearance of expansion and suspension. The excess intercalator was removed by a tubularis, and 10 g of PMAA was then added to the intercalated graphite to be evenly stirred. The mixture was put into a microwave reactor to perform a pyrolysis addition reaction for 1 minute. While the PMAA included a lot of negative charges such as COO⁻ functional group, it could diffuse into the interlayer of the intercalated graphite by charge attraction. As a result, a PMAA intercalated graphite was formed with a brown-black color. The PMAA intercalated graphite was added into excess amount of ethanol to be supersonic vibrated until no bubbles were produced (for about 1 hour). The excess intercalator, PMAA, and ethanol were removed by centrifugal washing, thereby collecting a product for further physical and structural analysis. The TEM photographs of the product were shown in FIGS. 3A, 3B, 4A, and 4B. As shown in FIG. 3A, a significant amount of the graphene sheet wrapped as nano scrolls. As shown in FIG. 3B, the interlayer distance of the graphite layers was similar to that of carbon nanotubes. As shown in FIG. 4A, the interlayer distance of the graphene scroll was 0.6 nm to 0.8 nm. As shown in FIG. 4B, the graphene scroll had an inner diameter of 2 nm.

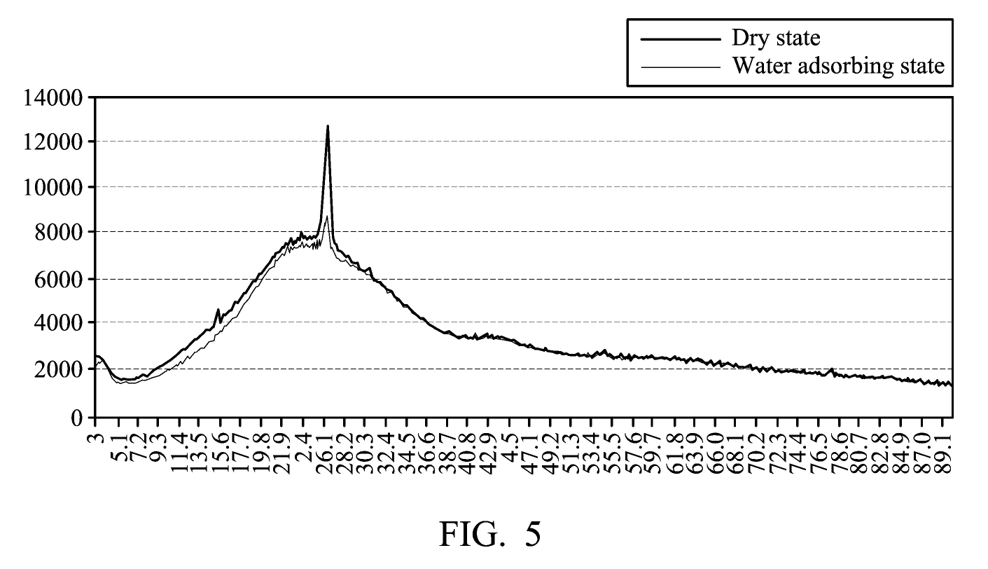

The product was analyzed by XRD, as shown in FIG. 5. The product had a peak value at (002). When the graphene scroll started to adsorb water from its dry state, the peak value at (002) was reduced. It means that the original wrapped structure will be loosened while the PMMA adsorbed water, thereby expanding the graphite interlayer distance to about 0.34 nm. As shown in FIG. 5, the original peak value at (002) was quietly reduced by expanding the graphene layers, and this change was beneficial to control the water adsorption amount of the PMAA in the graphene scroll. When the temperature was increased, the product would release water of crystallization.

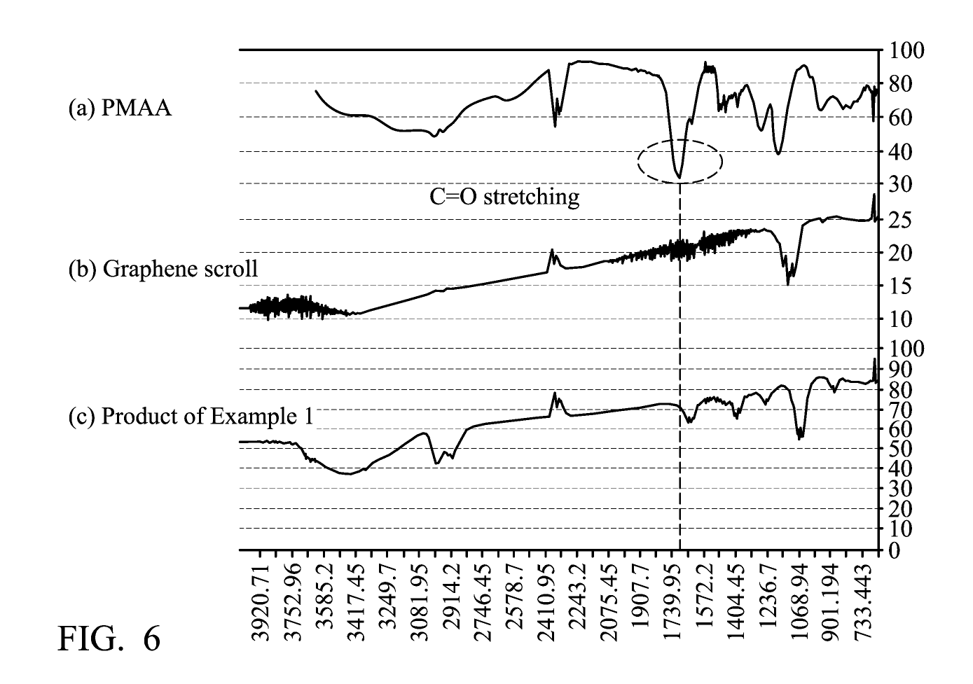

For checking whether the PMAA grafted onto the graphene scroll in Example 1 or not, the PMAA, the graphene scroll in Comparative Example 1, and the product in Example 1 were analyzed by a FT-IR spectrometer as shown in FIG. 6. The C═O character peak of PMAA was 1718cm⁻¹, and the C═O character peak of the product in Example 1 was shifted to 1656cm⁻¹. It may prove that the PMAA could be grafted on the graphene scroll by the steps in Example 1.

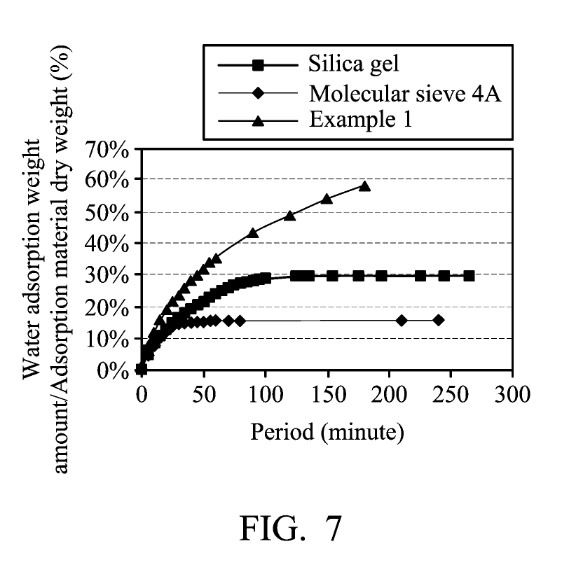

Subsequently, the product in Example 1, the PMAA, the silica gel (specific surface area=300 m²/g, pore size=about 10 nm, commercially available from Aldrich), and molecular sieve 4A (pore size=0.4 nm, commercially available from Alfa) were put into a constant temperature and humidity box with a relative humidity of 80% at 25° C., and the test results are shown in FIG. 7. The molecular sieve 4A had a faster water vapor adsorption rate, but had a saturated adsorption amount of only 16%. The silica gel had a saturated adsorption amount of over 30%. The product in Example 1 had an adsorption amount of over 58% (unsaturated). Obviously, the water vapor adsorption amount of the graphene scroll had a larger flexibility.

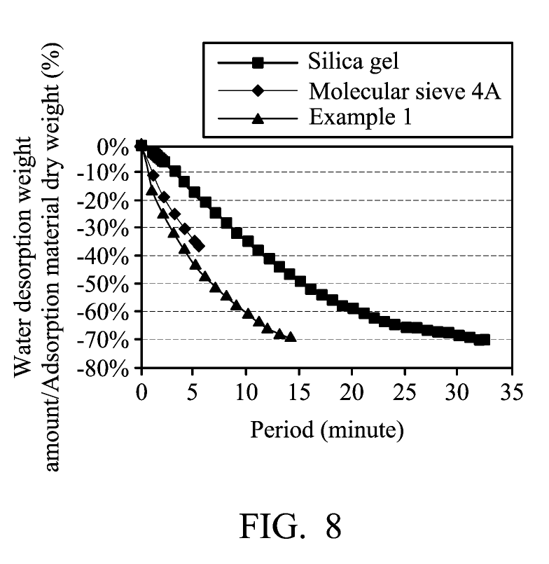

The water adsorbing materials were put at 80° C. to test their water desorption rate, as shown in FIG. 8. The product in Example 1 had the highest water vapor desorption rate (desorption amount of 70 wt % in 14 minutes). The silica gel needed at least 30 minutes to achieve a desorption amount of 70 wt %. The molecular sieve 4A could not desorb the water vapor at this condition.

The adsorption/desorption properties of the silica gel, the molecular sieve 4A, the graphene scroll in Comparative Example 1, and the PMAA, and the product in Example 1 are listed in Table 1.

TABLE 1

| | Adsorption | | Desorption | |
|---|---|---|---|---|
| | amount | | amount | |
| | (water weight/ | | (water weight/ | |
| | adsorption | | adsorption | |
| | material dry | Period | material dry | Period |
| | weight) | (min) | weight) | (min) |
| Silica gel | 0.13 | 30 | 0.1 | 30 |
| Molecular sieve | 0.14 | 30 | 0.02 | 5 |
| 4A | | | | |
| Comparative | 0.019 | 30 | 0.001 | 5 |
| Example 1 | | | | |
| PMAA | 0.046 | 30 | 0.004 | 30 |
| Example 1 | 0.23 | 30 | 0.16 | 15 |

As shown in Table 1, the product in Example 1 had an adsorption amount, desorption amount, and desorption period that were better those of the silica gel, the molecular sieve 4A, and the graphene scroll in Comparative Example 1, and the PMAA.

Adsorption isotherms of the silica gel, the molecular sieve 4A, and the product in Example 1 were measured to be calculated by Clausius-Clapeyron Equation to obtain their adsorption heat. In addition, the coefficient of performance (COP) and the specific cooling power (SCP) of the silica gel, the molecular sieve 4A, and the product in Example 1 were calculated by their adsorption-desorption cycle characters without considering their thermal change, as shown in Tables 2 and 3. The product in Example 1 had the COP being 1.21 times greater than that of the silica gel, and the SCP being 2.1 times greater than that of the silica gel.

TABLE 2

| | Adsorption heat (MJ/mole) | COP |
|---|---|---|
| Silica gel | 0.5043 | 0.809 |
| Molecular sieve 4A | 0.7569 | 0.539 |
| Example 1 | 0.4165 | 0.979 |

TABLE 3

| | Adsorption-desorption | Cycle time | |
|---|---|---|---|
| | cycle amount (ΔX) | (min) | SCP (W/Kg) |
| Silica gel | 0.10 | 60 | 63 |
| Molecular sieve 4A | 0.02 | 35 | 22 |
| Example 1 | 0.16 | 45 | 133 |

### Example

### SDBS Grafted Graphene Scroll

Appropriate amount of graphite powder was added into 200 mL of perchloric acid (70-72 wt %)/nitric acid (>65 wt %) (v/v=0.25 to 1), and then evenly stirred until the graphite powder stopped bubbling (for about 2 hours). As such, a graphite intercalated by the perchloric acid and the nitric acid was obtained, which had an appearance of expansion and suspension. The excess intercalator was removed by a tubularis, and 5 g of SDBS was then added to the intercalated graphite to be evenly stirred. The mixture was put into a microwave reactor to perform a pyrolysis addition reaction for 1 minute. While the SDBS included a lot of negative charges such as SO₃⁻ functional group, it could diffuse into the interlayer of the intercalated graphite by charge attraction. As a result, a SDBS intercalated graphite was formed with a brown-black color. The SDBS intercalated graphite was added into excess amount of ethanol to be supersonic vibrated until no bubbles were produced (for about 1 hour). The excess intercalator, SDBS, and ethanol were removed by centrifugal washing, thereby collecting a product of SDBS grafted graphene scroll.

### Example 3

### SDBS and PMAA Grafted Graphene Scroll

Appropriate amount of graphite powder was added into 200 mL of perchloric acid (70-72 wt %)/nitric acid (>65 wt %) (v/v=0.25 to 1), and then evenly stirred until the graphite powder stopped bubbling (for about 2 hours). As such, a graphite intercalated by the perchloric acid and the nitric acid was obtained, which had an appearance of expansion and suspension. The excess intercalator was removed by a tubularis, and 5 g of SDBS was then added to the intercalated graphite to be evenly stirred. The mixture was put into a microwave reactor to perform a pyrolysis addition reaction for 1 minute. While the SDBS included a lot of negative charges such as SO₃⁻ functional group, it could diffuse into the interlayer of the intercalated graphite by charge attraction. 10 g of PMAA was then added into the SDBS intercalated graphite to be evenly stirred. The mixture was put into a microwave reactor to perform a pyrolysis addition reaction for 1 minute. While the PMAA included a lot of negative charges such as COO⁻ functional group, it could diffuse into the interlayer of the SDBS intercalated graphite by charge attraction. As a result, a SDBS and PMAA intercalated graphite was formed with a brown-black color. The SDBS and PMAA intercalated graphite was added into excess amount of ethanol to be supersonic vibrated until no bubbles were produced (for about 1 hour). The excess intercalator, SDBS, PMAA, and ethanol were removed by centrifugal washing, thereby collecting a product of SDBS and PMAA grafted graphene scroll.

### Example 4

### PMAA Grafted Graphene Scroll Covered by Water Retention Agent

2 g of alginate (160-200QG, commercially available from Gemfont Cooperation) was added into the graphene scroll product in Example 3 to be evenly stirred, thereby forming a charged macromolecule. The charged macromolecule can be hydrated to have a viscosity, and interacted with multivalent metal ions to process a gel reaction. As a result, a graphene scroll covered by the sodium alginate was obtained. Thereafter, the water adsorption ability of the product was analyzed by the water vapor adsorption experiment mentioned in Example 1.

### Example 5

### PMAA Grafted Graphene Scroll Covered by Water Retention Agent

4 g of ammonium polyacrylate (03311, commercially available from ECHO CHEMICAL CO., LTD) was added into the graphene scroll product in Example 3 to be evenly stirred, thereby forming a graphene scroll covered by the ammonium polyacrylate. Thereafter, the water adsorption ability of the product was analyzed by the water vapor adsorption experiment mentioned in Example 1.

### Example 6

### PMAA Grafted Graphene Scroll Covered by Water Retention Agent

1 g of poly(vinyl alcohol) (341584, commercially available from Aldrich) was added into the graphene scroll product in Example 3 to be evenly stirred, thereby forming a graphene scroll covered by the polyvinyl alcohol. Thereafter, the water adsorption ability of the product was analyzed by the water vapor adsorption experiment mentioned in Example 1.

TABLE 4

| | Adsorption capacity (water | |
|---|---|---|
| | weight/adsorption material | |
| | dry weight) | Period (min) |
| Silica gel | 0.29 | 180 |
| Molecular sieve 4A | 0.15 | 180 |
| Example 2 | 0.25 | 180 |
| Example 3 | 0.58 | 180 |
| Example 4 | 0.32 | 180 |
| Example 5 | 0.07 | 180 |
| Example 6 | 0.29 | 180 |

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. An adsorption material, comprising:
a graphene scroll of a graphene sheet wrapping along an axis, wherein the graphene scroll has a spiral shape at a cross-section perpendicular to the axis; and
a modifier grafting on an interlayer and outside of the graphene scroll, wherein the modifier has a hydrophilic group.

2. The adsorption material as claimed in claim 1, wherein the graphene scroll and the modifier have a weight ratio of 1:0.5 to 1:5.

3. The adsorption material as claimed in claim 1, wherein the modifier comprises a surfactant, a hydrophilic polymer, or a combination thereof.

4. The adsorption material as claimed in claim 3, wherein the surfactant comprises sodium dodecylbenzenesulfonate, polyoxyethylene ether sulfate, polyoxyethylene alkyl ether, or polyethylene polyamine fatty acid amine salt.

5. The adsorption material as claimed in claim 3, wherein the hydrophilic polymer has a weight average molecular weight of 10000 to 500000.

6. The adsorption material as claimed in claim 3, wherein the hydrophilic polymer comprises poly(methacrylic acid), poly(ethylene glycol), polyacrylonitrile, acrylic ester-acrylamide copolymer, ethylene-maleic anhydride copolymer, carboxylicmethyl cellulose, or starch-grafted polyacrylonitrile.

7. The adsorption material as claimed in claim 3, wherein the hydrophilic polymer has hydrophilic groups of sodium sulfonate, and the hydrophilic polymer includes poly(sodium styrenesulfonate) or sodium lignosulfonate.

8. The adsorption material as claimed in claim 3, wherein the hydrophilic polymer has hydrophilic groups of amine group, and the hydrophilic polymer includes polyacrylamide, polyvinylpyrrolidone, polyethylenimine, or poly(diallyldimethylammonium chloride).

9. The adsorption material as claimed in claim 1, further comprising a water retention agent covering the graphene scroll, and the water retention agent includes sodium alginate, poly(acrylic acid) or a salt thereof, poly(ethylene glycol), or poly(vinyl alcohol).

10. A method of manufacturing an adsorption material, comprising:
(a) mixing a graphite and an intercalator to form a first intercalated graphite;
(b) mixing the first intercalated graphite and a modifier to form a mixture, and applying a microwave to the mixture to form a second intercalated graphite;
(c) putting the second intercalated graphite in an alcohol for a supersonic vibration to form an adsorption material, wherein the adsorption material includes:
a graphene scroll of a graphene sheet wrapping along an axis, wherein the graphene scroll has a spiral shape at a cross-section perpendicular to the axis; and
the modifier grafting on an interlayer and outside of the graphene scroll, wherein the modifier has a hydrophilic group.

11. The method as claimed in claim 10, wherein the intercalator comprises sulfuric acid, perchloric acid, nitric acid, phosphoric acid, stearic acid, or a combination thereof.

12. An adsorption heat pump, comprising:
an adsorption/desorption portion including an adsorption material for adsorbing/desorbing a refrigerant; and
an evaporation portion for evaporating the refrigerant, wherein the evaporation portion connects to the adsorption/desorption portion; and
a condensation portion for condensing the refrigerant, wherein the condensation portion connects to the adsorption/desorption portion,
wherein the adsorption material includes:
a graphene scroll of a graphene sheet wrapping along an axis, wherein the graphene scroll has a spiral shape at a cross-section perpendicular to the axis; and
a modifier grafting on an interlayer and outside of the graphene scroll, wherein the modifier has a hydrophilic group.
